(19) United States
(12) Patent Application Publication
(10) Pub. No.: US 2011/0069759 A1
(43) Pub. Date: Mar. 24, 2011

(54) INTERPOLATION METHOD AND VIDEO CODEC DEVICE USING THE SAME

(75) Inventors: YI-SHIN LI, Tu-Cheng (TW); SHENG-WEI LIN, Tu-Cheng (TW)

(73) Assignee: HON HAI PRECISION INDUSTRY CO., LTD., Tu-Cheng (TW)

(21) Appl. No.: 12/646,883

(22) Filed: Dec. 23, 2009

(30) Foreign Application Priority Data
Sep. 23, 2009 (CN) 200910307499.X

(51) Int. Cl. H04N 7/26

(52) U.S. Cl. 375/240.15; 375/E07.188

(57) ABSTRACT

A video codec device to perform interpolations on a reference frame is provided. The video codec device comprises a full pixel register, an interpolation filter array, a half pixel register and a result register. The interpolation filter array performs half interpolations to generate half pixels of the reference frame to the half pixel register. The half pixels stored in the half pixel register are variable for quarter interpolations. When all the half interpolations of the reference frames are finished, the interpolation filter array performs the quarter interpolations utilizing the generated half pixels, and generates quarter pixels of the reference frames to the result register.

### BACKGROUND

1. Technical Field

Embodiments of the present disclosure relate to video codec devices, and particularly to an interpolation method and a video codec device using the same.

2. Description of Related Art

In order to improve codec performance, video codec devices usually compare full, half and quarter pixels of macro blocks of a current frame with those of reference frames so as to determine the macro blocks most similar to that of the current frame, known as “best prediction macro blocks”.

Referring to FIG. 5, a commonly used interpolation method for generating the half and quarter pixels is shown, wherein capital letters A-T indicate the full pixels, single small letters a-n indicate the half pixels, and dual small letters aa-qq indicate the quarter pixels. In order to acquire each quarter pixel, a commonly used video codec device performs a half interpolation and a quarter interpolation according to the H.264 standard. For example, in order to acquire the quarter pixel aa, the half interpolation upon the full pixels E, F, G, H, I and J is executed to generate the half pixel a, then the quarter interpolation upon the full pixel G and the half pixel a is executed to generate the quarter pixel aa.

It is obvious that the half pixels a, b, d and e are also required for the quarter interpolation to generate the quarter pixels of adjacent macro blocks. However, the commonly used video codec device must repeat the half interpolations to generate the half pixels a, b, d and e, then the quarter interpolations upon the half pixels a, b, d and e and the full pixels to generate the quarter pixels of adjacent macro blocks. Therefore, the half and quarter interpolations of the video codec device are often computationally complex and inefficient.

### BRIEF DESCRIPTION OF THE DRAWINGS

Many aspects of the embodiments can be better understood with references to the following drawings, wherein like numerals depict like parts, and wherein:

FIG. 1 is a schematic diagram of a video codec device in accordance with one embodiment of the present disclosure;

FIG. 2 is a flowchart of an interpolation method in accordance with one embodiment of the present disclosure;

FIG. 3 is a detailed flowchart of half interpolations of the interpolation method in accordance with one embodiment of the present disclosure;

FIG. 4 is a detailed flowchart of quarter interpolations of the interpolation method in accordance with one embodiment of the present disclosure; and

FIG. 5 illustrates a commonly used interpolation method for generating the half and quarter pixels.

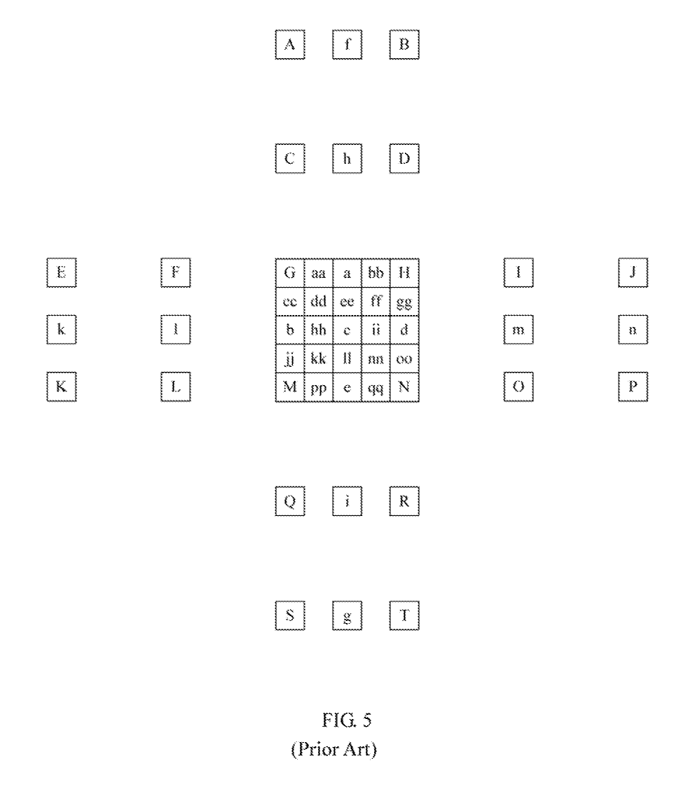

### DETAILED DESCRIPTION

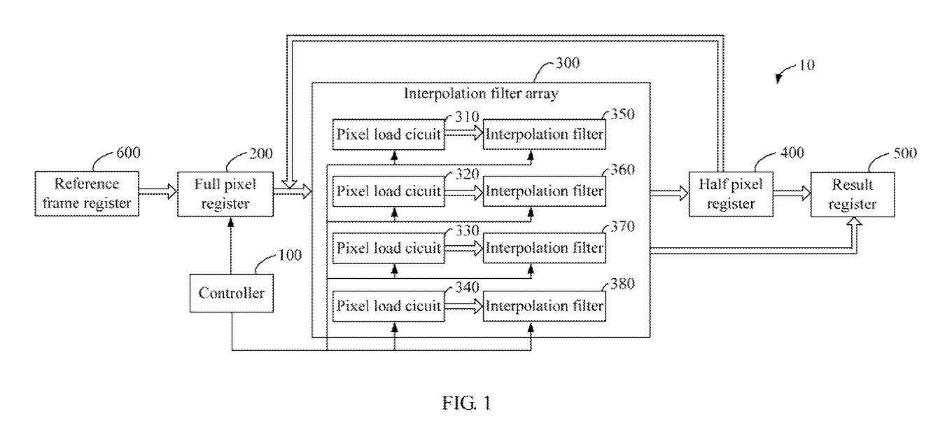

Referring to FIG. 1, a schematic diagram of a video codec device 10 in accordance with the present disclosure is shown. The video codec device 10 performs half and quarter interpolations to generate half and quarter pixels of reference frames stored in a reference frame register 600. In one embodiment, the video device 10 comprises a controller 100, a full pixel register 200, an interpolation filter array 300, a half pixel register 400 and a result register 500.

The controller 100 controls operations of the full pixel register 200, the interpolation filter array 300, the half pixel register 400 and the result register 500.

The full pixel register 200 reads full pixels of the reference frames from the reference frame register 600, and transmits the full pixels required for the half and quarter interpolations to the interpolation filter array 300.

The interpolation filter array 300 performs the half interpolations to generate the half pixels of the reference frames to the half pixel register 400. The interpolation filter array 300 performs the quarter interpolations to generate the quarter pixels of the reference frames to the result pixel register 500. The interpolation filter array 300 comprises a plurality of pixel load circuits to load pixels in parallel, and a plurality of interpolation filters to perform the half or quarter interpolation in parallel correspondingly.

In one embodiment, the interpolation filter array 300 comprises four pixel load circuits 310-340 and four interpolation filters 350-380 correspondingly. The pixel load circuits 310-340 are connected to the full pixel register 200 in parallel, each of which individually loads the full pixels of the reference frames from the full pixel register 200 in a pipeline operation. Additionally, the pixel load circuits 310-340 are connected to the half pixel register 400 in parallel, and individually load the half pixels of the reference frames from the half pixel register 400 in a pipeline operation. The interpolation filters 350-380 are correspondingly connected to the pixel load circuits 310-340, respectively. The interpolation filters 350-380 read the full pixels loaded by the corresponding pixel load circuits 310-340, and perform the half interpolations upon the full pixels to generate the half pixels of the reference frames, which are stored in the half pixel register 400. Then, the interpolation filters 350-380 further read the full and half pixels loaded by the corresponding pixel load circuits 310-340, and perform the quarter interpolations upon the full and half pixels to generate the quarter pixels of the reference frames, which are stored in the result register 500.

The half pixel register 400 receives and stores the half pixels generated by the interpolation filer array 300. In this embodiment, the half pixel register 400 further provides the half pixels required for the subsequent quarter interpolations to the interpolation filter array 300 so as to avoid repeated half interpolations in the commonly used video codec devices.

The result register 500 receives and stores the quarter pixels generated by the interpolation filter array 300. In this embodiment, when all the quarter interpolations of the reference frame are completed, the half pixel register 400 transfers the half pixels to the result register 500, and the result register 500 receives and stores the half pixels.

In the embodiment, the video codec device 10 performs the half interpolations upon the full pixels to generate the half pixels of the reference frames, and stores the generated half pixels in the half pixel register 400. When all the half interpolations of the reference frame are completed, the video codec device 10 performs the quarter interpolations upon the full pixels and the stored half pixels to generate the quarter pixels of the reference frame, and stores the generated quarter pixels in the result register 500.

In the half interpolations of the reference frame, the full pixel register 200 reads the full pixels of the reference frame required for the half and quarter interpolations from the reference frame register 600. The interpolation filter array 300 loads the full pixels required for the half interpolations from the full pixel register 200, and performs the half interpolations to generate the half pixels in batches.

In the embodiment, each of the pixel load circuits 310-340 loads a portion of full pixels required for a half interpolation, then each of the interpolation filters 350-380 correspondingly reads the loaded portion of full pixels and performs the half interpolation to generate a half pixel of the reference frame to the half pixel register 400. The controller 100 determines whether all the half interpolations of the reference frame are completed. If the half interpolations of the reference frame are not all completed, each of the pixel load circuits 310-340 of the interpolation filter array 300 loads the next portion of full pixels required for next half interpolation. Then, each of the interpolation filters 350-380 of the interpolation filter array 300 correspondingly reads the next portion of full pixels loaded by the pixel load circuits 310-340, and performs the next interpolation to generate another half pixel of the reference frame to the half pixel register 400.

If all the half interpolations of the reference frame are completed, the video codec device 10 begins the quarter interpolations to generate the quarter pixels of the reference frame. In this embodiment, the generated half pixels of the reference frame are stored in the half pixel register 400.

To obtain the quarter pixels of the reference frame, the interpolation filter array 300 loads the full pixels from the full pixel register 200 and the half pixels from the half pixel register 400, and performs the quarter interpolations to generate the quarter pixels of the reference frame in batches. The generated quarter pixels are stored in the result register 500.

Each of the pixel load circuits 310-340 of the interpolation filter array 300 loads a portion of full and half pixels required for a quarter interpolation. In the embodiment, the full pixels are loaded from the full pixel register 200, and the half pixels are loaded from the half pixel register 400. Each of the interpolation filters 350-380 of the interpolation filter array 300 correspondingly reads the portion of full and half pixels loaded by the pixel load circuits 310-340, and performs the quarter interpolation to generate a quarter pixel of the reference frame to the result register 500. The controller 100 determines whether all the quarter interpolations of the reference frame are completed. If the quarter interpolations of the reference frame are not completed, each of the pixel load circuits 310-340 of the interpolation filter array 300 loads the next portion of full and half pixels required for next quarter interpolation. Then, each of the interpolation filters 350-380 of the interpolation filter array 300 correspondingly reads the next portion of full and half pixels loaded by the pixel load circuits 310-340, and performs the next quarter interpolation to generate another quarter pixel of the reference frame to the result register 500.

If all the quarter interpolations of the reference frame are completed, the half pixel register 300 transfers the half pixels of the reference frame to the result register 500. Then, the half pixels and quarter pixels of the reference frame are stored in the result register 500.

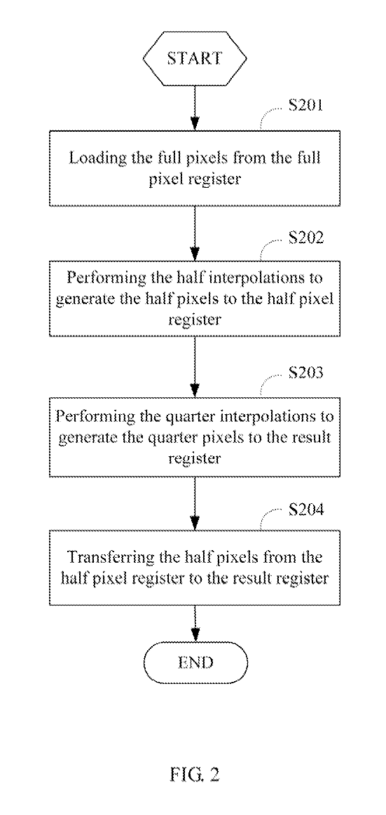

Referring to FIG. 2, a flowchart of an interpolation method to generate the half and quarter pixels in accordance with the present disclosure is shown. In the embodiment, the interpolation method comprises a plurality of steps as follows.

In step S201, the full pixel register 200 reads the full pixels required for the half interpolations and quarter interpolations of a reference frame from the reference frame register 600.

In step S202, the interpolation filter array 300 loads the full pixels from the full pixel register 200, and performs the half interpolations to generate the half pixels in batches. The generated half pixels of the reference frame are stored in the half pixel register 400.

In step S203, when all the half interpolations of the reference frame are completed, the interpolation filter array 300 loads the full pixels from the full pixel register 200 and the half pixels from the half pixel register 400, and performs the quarter interpolations to generate the quarter pixels of the reference frames in batches. The generated quarter pixels are stored in the result register 500.

In step S204, when all the quarter interpolations of the reference frame are completed, the half pixel register 400 transfers the half pixels of the reference frame to the result pixel register 500.

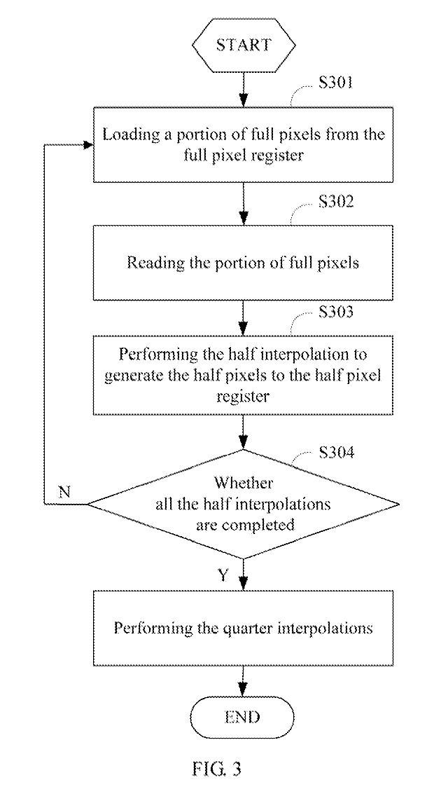

Referring to FIG. 3, a detailed flowchart of the half interpolations of the interpolation method in accordance with the present disclosure is shown. In the embodiment, the half interpolations of the interpolation method comprise a plurality of steps as follows.

In step S301, each of the pixel load circuits 310-340 of the interpolation filter array 300 loads a portion of full pixels required for a half interpolation from the full pixel register 200.

In step S302, each of the interpolation filters 350-380 of the interpolation filter array 300 correspondingly reads the portion of full pixels loaded by the pixel load circuits 310-340.

In step S303, each of the interpolation filters 350-380 of the interpolation filter array 300 performs the half interpolation upon the portion of full pixels to generate a half pixel to the half pixel register 400.

In step S304, the controller 100 determines whether all the half interpolations of the reference frame are completed. If the half interpolations of the reference frame are not all completed, each of the pixel load circuits 310-340 of the interpolation array 300 loads the next portion of full pixels required for next half interpolation, and performs the next half interpolation to generate another half pixel to the half pixel register 300. If all the half interpolations of the reference frame are completed, the video codec device 10 begins performing the quarter interpolations of the reference frame. In the embodiment, the generated half pixels of the reference frame are stored in the half pixel register 400.

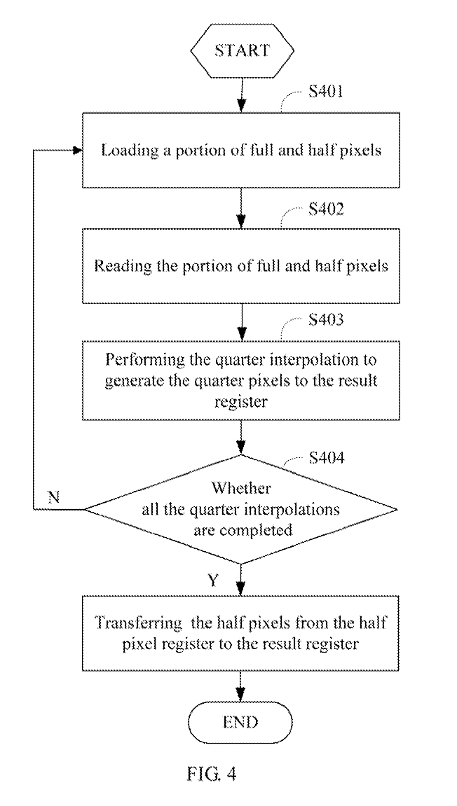

Referring to FIG. 4, a detailed flowchart of the quarter interpolations of the interpolation method in accordance with the present disclosure is shown. In the embodiment, the quarter interpolations of the interpolation method comprise a plurality of steps as follows.

In step S401, each of the pixel load circuits 310-340 of the interpolation filter array 300 loads a portion of full and half pixels required for a quarter interpolation. In the embodiment, the full pixels are loaded from the full pixel register 200, and the half pixels are loaded from the half pixel register 400.

In step S402, each of the interpolation filters 350-380 of the interpolation filter array 300 reads the portion of full and half pixels loaded by the corresponding pixel load circuits 340-380.

In step S403, each of the interpolation filters 350-380 of the interpolation filter array 300 performs the quarter interpolation to generate a quarter pixel of the reference frame to the result register 500.

In step S404, the controller 100 determines whether all the quarter interpolations of the reference frame are completed. If the quarter interpolations of the reference frame are not all completed, then each of the pixel load circuits 310-340 loads the next portion of full and half pixels required for next quarter interpolation, and performers the next quarter interpolation to generate another quarter pixel to the result register 500. If all the quarter interpolations of the reference frame are completed, the half pixel register 400 transfers all the half pixels of the reference frame to the result register 500.

It is apparent that the present disclosure provides an interpolation method and a video codec device using the same operable to perform the quarter interpolations utilizing generated half pixels stored in a half pixel register. Therefore, computational complexity and intensity of the quarter interpolations decrease with elimination of repeated half interpolations, and efficiency of the video codec devices increases.

While the present disclosure has been described in combination with embodiments thereof, it is evident that many alternatives, modifications, and variations will be apparent to those skilled in the art in light of the foregoing description. Accordingly, it is intended to embrace all such alternatives, modifications, and variations as fall within the spirit and scope of the appended claims.

What is claimed is:

1. A video codec device to perform interpolations on reference frames, the video codec device comprising:
a full pixel register to read full pixels of the reference frames;
an interpolation filter array to perform half interpolations to generate half pixels of the reference frame, and perform quarter interpolations utilizing the generated half pixels of the reference frames;
a half pixel register to store the generated half pixels of the reference frame and provide the generated half pixels to the interpolation filter array for the quarter interpolations;
a result register to store the quarter pixels, and to receive and store the half pixels of the reference frames transferred from the half pixel register; and
a controller to control operations of the full pixel register, the interpolation filter array, the half pixel register and the result register.

2. The video codec device as claimed in claim 1, wherein the interpolation filter array comprises:
a plurality of pixel load circuits connected in parallel with the full pixel register to load the full pixels, and connected in parallel with the half pixel register to load the generated half pixels;
a plurality of interpolation filters correspondingly connected to the plurality of pixel load circuits to perform the half interpolations and the quarter interpolations utilizing the loaded full pixels and half pixels.

3. An interpolation method to perform interpolations on reference frames, the interpolation method comprising:
reading full pixels of the reference frames from a reference frame register, and storing the full pixels of the reference frames in a full pixel register;
loading the full pixels from the full pixel register;
performing half interpolations upon the loaded full pixels to generate half pixels of the reference frame and storing the generated half pixels in a half pixel register;
loading the full pixels from the full pixel register and the generated half pixels from the half pixel register, and
performing quarter interpolations upon the loaded full and the half pixels to generate quarter pixels of the reference frame and storing the quarter pixels in a result register.

4. The interpolation method as claimed in claim 3, further comprising transferring the half pixels from the half pixel register to the result register when all the quarter interpolations of the reference frame are finished.

5. The interpolation method as claimed in claim 3, wherein the half interpolations of the reference frame comprise:
loading a portion of full pixels from the full pixel register;
performing the half interpolation upon the portion of full pixels to generate a half pixel of the reference frame and storing the generated half pixel in the half pixel register;
determining whether all the half interpolations of the reference frame are completed;
loading the next portion of full pixels and performing half interpolation upon the next portion of full pixels, if the half interpolations of the reference frame are not all completed.

6. The interpolation method as claimed in claim 5, further comprising performing the quarter interpolations if all the half interpolations of the reference frame are completed.

7. The interpolation method as claimed in claim 5, wherein the half interpolations of the reference frames are performed by a plurality of interpolation filter arrays in parallel.

8. The interpolation method as claimed in claim 7, wherein the interpolation filter array comprises:
a plurality of pixel load circuits connected in parallel with the full pixel register to load the full pixels;
a plurality of interpolation filters correspondingly connected to the plurality of pixel load circuits to perform the half interpolations.

9. The interpolation method as claimed in claim 3, wherein the quarter interpolations of the reference frame comprise:
loading a portion of full and half pixels from the full pixel register and the half pixel register, respectively;
performing the quarter interpolation upon the portion of full and half pixels to generate a quarter pixel of the reference frame, and storing the generated quarter pixel in the result register;
determining whether all the quarter interpolations of the reference frame are completed;
loading the next portion of full and half pixels and performing the half interpolation upon the next portion full pixels, if the quarter interpolations of the reference frame are not all completed.

10. The interpolation method as claimed in claim 8, wherein the quarter interpolations of the reference frame are performed by a plurality of interpolation filter arrays in parallel.

11. The interpolation method as claimed in claim 10, wherein the interpolation filter array comprises:
a plurality of pixel load circuits connected in parallel with the full pixel register to load the full pixels, and connected in parallel with the half pixel register to load the generated half pixels;
a plurality of interpolation filters correspondingly connected to the plurality of pixel load circuits to perform the quarter interpolations.
